(19) United States
(12) Patent Application Publication
(10) Pub. No.: US 2007/0275594 A1
(43) Pub. Date: Nov. 29, 2007

(54) Multipurpose power center

(75) Inventor: Michael Greenberg, Bloomfield, CT (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: United Technologies Corporation, Hartford, CT (US)

(21) Appl. No.: 11/439,048

(22) Filed: May 23, 2006

(51) Int. Cl. H01R 13/72

(52) U.S. Cl. 439/501

(57) ABSTRACT

A multipurpose power center comprises a housing, a cover member, a plurality of electrical outlets, an electrical cable, and a connection port coupled to the cover member. The housing has an outer surface, a top side, a bottom side, and an opening extending from the top side to the bottom side. The cover member is configured to encase the opening on the top side of the housing. The electrical outlets are positioned along the outer surface of the housing, and the electrical cable is connectable to a power source and configured to provide electrical power to the electrical outlets.

### BACKGROUND

The present invention relates to a multipurpose power center having a plurality of electrical outlets. More particularly, the present invention relates to a portable, multipurpose power center removably positionable on a substantially flat surface and configured to provide a source of electrical power and connection to a network.

As a result of technology advances in recent years, it is very common for people to carry around and communicate with each other through laptop computers and portable projectors, especially in the workplace. For example, it is common for individuals sitting around a conference table during a business meeting to utilize their portable laptop computers to present information and record meeting notes. Furthermore, access to the internet or network hard drives may also be required during such meetings. Thus, there is a need for both electrical and network access in conference rooms and near conference tables.

In some conference room set-ups, access to electrical and network connections is limited to wall outlets positioned along the outer walls of the conference room. Therefore, if an individual wants to utilize a laptop computer, he or she must run the cables from the table area to the wall outlets. This is not only inconvenient, but it also results in a potential safety hazard for others stepping on the cables as they walk past the conference table.

In other conference room set-ups, the electrical and network connections may reside beneath the table. This type of set-up may improve safety, but the position of the outlets may result in awkward reaching or bending to access the outlets.

In yet other conference room set-ups, the conference table may include a power center with built-in electrical outlets and network connections that are permanently wired into the table. Since the power centers are built into the table, and the electrical outlets and network connections are wired directly into the table, the power centers are not movable. Furthermore, if there becomes a need for a new or different type of connection, the table wiring must be reconfigured to accommodate the new connection. As a result, the various connections on these permanently wired tables are not easily interchangeable.

Thus, there exists a need for a multipurpose power center that is easily movable between various locations without special tools and allows for interchangeability of outlets and connection ports.

### BRIEF SUMMARY

The present invention is a multipurpose power center comprising a housing, a cover member, a plurality of electrical outlets, an electrical cable, and a connection port coupled to the cover member. The housing has an outer surface, a top side, a bottom side, and an internal opening extending from the top side to the bottom side. The cover member is configured to encase the opening on the top side of the housing. The electrical outlets are positioned along the outer surface of the housing, and the electrical cable is connectable to a power source and configured to provide electrical power to the electrical outlets.

### BRIEF DESCRIPTION OF THE DRAWINGS

FIG. 1 is a perspective view of a multipurpose power center.

FIG. 2 is a cross-sectional view of the multipurpose power center resting on a substantially flat surface.

FIG. 3 is a bottom perspective view of the multipurpose power center.

FIG. 4 is a cross-section view of the multipurpose power center showing one embodiment of a surge suppressor.

FIG. 5A is a perspective view of a first alternative embodiment of an interchangeable cover member.

FIG. 5B is a perspective view of a second alternative embodiment of an interchangeable cover member.

FIG. 5C is a perspective view of a third alternative embodiment of an interchangeable cover member.

FIG. 6 is a perspective view of another embodiment of a multipurpose power center.

### DETAILED DESCRIPTION

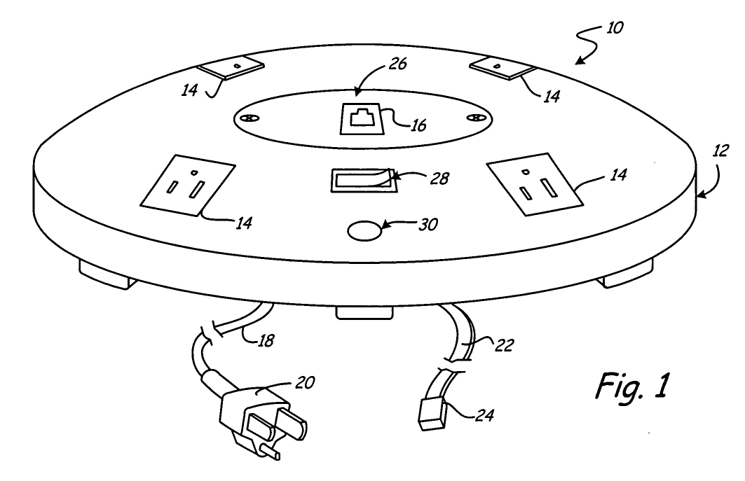

FIG. 1 is a perspective view of multipurpose power center 10, which includes housing 12, plurality of electrical outlets 14, network port 16, power cable 18, power plug 20, network cable 22, network plug 24, and cover 26. As shown in FIG. 1, electrical outlets 14 are configured to receive two-prong or three-prong electrical plugs, while network port 16 is configured to receive a standard network plug, such as the type typically connected to a twisted pair cable. Power center 10 is configured to rest on a substantially flat surface, such as a conference table in a conference room. Furthermore, because it is not necessary to fixedly attach power center 10 to any surface during installation, it is easily movable between various locations with little effort and without the use of any tools.

As shown in FIG. 1, network port 16 is attached to cover member 26. Cover member 26 may be formed as part of housing 12, or may be formed as a separate component that is removably attachable to housing 12 through use of some fastening means. However, the following discussion will focus on cover members that are formed as separate components and made removable from housing 12. As will be discussed in more detail later, cover member 26 may be removed and replaced with numerous other cover members having a different number or different types of connection ports. Since cover member 26 is interchangeable with numerous other cover members, multipurpose power center 10 may be transformed into a multitude of different embodiments simply by interchanging cover members, thus allowing a user to tailor multipurpose power center 10 to their particular needs. Furthermore, as technology changes, it is inevitable that new types of cables and connectors will arise. Due to the interchangeability of the cover members, multipurpose power center 10 may be adapted for use with any future connection type simply by creating a cover member with the new connection port.

In one embodiment, electrical outlets 14 are molded into housing 12, thereby forming a single part. In other embodiments, electrical outlets 14 are formed as separate components that are later inserted into a plurality of openings within housing 12.

As shown in FIG. 1, power cable 18 extends in a downward direction from an underside of housing 12. Power cable 18 terminates in power plug 20, which is configured to plug into an electrical source to provide power to electrical outlets 14. Electrical outlets 14 are wired together inside housing 12, and are preferably connected in parallel with each other so that if one of the outlets ceases functioning properly, it will not affect the transmission of power to the remaining outlets. However, electrical outlets 14 may alternatively be wired in series. Although power plug 20 is shown in FIG. 1 as a standard three prong plug such as the type typically found in the United States, power plug 20 may be substituted with any other type of power plug without departing from the spirit or scope of the present invention. Similarly, electrical outlets 14 maybe substituted with other types of electrical outlets as well. Thus, it is contemplated that power center 10 may be configured for use with the various electrical current, voltage, and plug types that are found all over the world.

As shown in FIG. 1, network cable 22 also extends in a downward direction from the underside of housing 12. Network cable 22 terminates in network plug 24, which is configured to plug into a network outlet, such as an ethernet outlet.

In other embodiments, multipurpose power center 10 may include a plurality of network ports 16 instead of a single port as shown in FIG. 1. Each of the network ports 16 may include a network cable 22 terminating in a separate network plug 24. Alternatively, each of the network ports 16 may be connected to a single network cable, and a multiplexer, router, or similar device may be used to separate the network connection through the single network cable. Furthermore, although multipurpose power center 10 is shown as having four electrical outlets 14, other embodiments may include a greater or lesser number of electrical outlets without departing from the spirit or scope of the present invention.

As shown in FIG. 1, multipurpose power center 10 may also include power switch 28 and indicator light 30. Power switch 28 is configured to toggle between an “on” position and an “off” position. After power plug 20 is plugged into an electrical power source, power switch 28 may be toggled between the “on” and “off” positions to control the power to electrical outlets 14. When power switch 28 is in the “on” position and electrical outlets 14 are receiving power, indicator light 30 will light up. On the other hand, when power switch 28 is in the “off” position and electrical outlets 14 are not receiving power, indicator light 30 will not light up. Thus, indicator light 30 serves as a visible signal indicating whether or not multipurpose power center 10 is plugged into the electrical power source and whether power switch 28 is turned “on” or “off.” In other embodiments, power switch 28 may be omitted from the power center. In that case, there is no separate “on/off” switch, and indicator light 30 will light up whenever power plug 20 is plugged into the electrical power source.

Power switch 28 and indicator light 30 provide convenience to a user by allowing the user to visually see whether power center 10 is plugged into the electrical power source merely by observing a top side of the power center, as well as by allowing the user to turn off power to electrical outlets 14 without removing electrical plug 20 from the electrical power source to which it is connected. However, neither one of these elements are a necessary component of the present invention. Thus, although multipurpose power center 10 is shown and described above as having a power switch and indicator light, power centers without these elements are also contemplated and within the intended scope of the present invention.

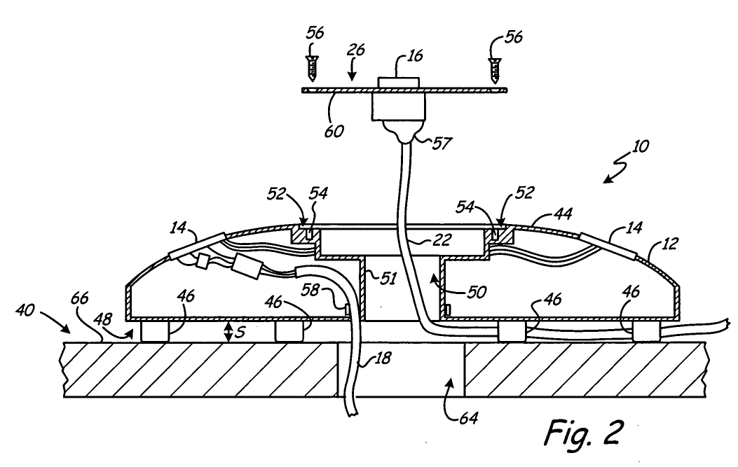

FIG. 2 is a cross-sectional view of multipurpose power center 10 resting on surface 40. As shown in FIG. 2, cover member 26 is removably attachable to top side 44 of housing 12. In addition, housing 12 includes a plurality of feet members 46 coupled to bottom side 48, opening 50 extending from top side 44 to bottom side 48, inner surface 51, shoulder 52, a pair of threaded holes 54 configured to receive a pair of fasteners 56, strain relief element 57, and power cable fastening element 58.

When attached to housing 12, cover member 26 is configured to encase opening 50 on top side 44. In order to attach cover member 26 to housing 12, cover member 26 is positioned within opening 50 such that bottom side 60 of cover member 26 is resting on shoulder 52, and a pair of apertures in cover member 26 are aligned with threaded holes 54. Fasteners 56 may then be inserted through the pair of apertures in cover member 26 and into threaded holes 54 in order to removably attach cover member 26 to housing 12. Although fasteners 56 are depicted in FIG. 2 as screws, other types of fasteners that allow for interchangeability of cover member 26, such as snaps or clips, may also be used. Furthermore, in other embodiments, cover member 26 may instead have a snap feature attachable to some portion of housing 12, such as an underside of shoulder 52, to removably attach cover member 26 to housing 12.

Opening 50 of housing 12 is sized so as to allow a plurality of cords or cables, such as network cable 22, to pass through bottom side 48 of housing 12. As shown in FIG. 2, surface 40 includes opening 64 similar in size to opening 50 of housing 12. Multipurpose power center 10 is particularly useful in combination with surfaces having an opening because it provides the option of routing a cable through the surface, as depicted by power cable 18, or between bottom side 48 of housing 12 and top side 66 of surface 40, as depicted by network cable 22. Routing cords or cables through openings 50 and 64 is not only convenient, but also results in an aesthetically pleasing look.

Inner wall 51 of opening 50 is designed to prevent contact between the electrical wires providing power to electrical outlets 14 and the cords or cables passing through opening 50. In addition, inner wall 51 prevents a person from reaching his or her fingers into opening 50 when cover member 26 is removed and contacting any of the electrical wires that provide power to electrical outlets 14.

Although opening 50 is depicted as a stepped bore, this configuration is shown merely for example and not limitation. As shown in FIG. 2, the purpose of the stepped bore configuration is to allow more room for connections in the area of cover member 26 and reduce the exit area of opening 50 along bottom side 48, thus providing more room for other wiring within housing 12.

As shown in FIG. 2, feet members 46 are configured to rest on surface 40 and create a spatial relationship S between bottom side 48 of housing 12 and top side 66 of surface 40. Spatial relationship S will vary with the height of feet members 46. However, it is preferred that spatial relationship S is such that cables including, but not limited to, electrical, network, telephone, audio, or video cables may be positioned between bottom side 48 of housing 12 and top side 66 of surface 40 as discussed above. In addition, feet members 46 preferably include an elastomer portion, such as a natural or synthetic rubber, configured to contact top side 66 of surface 40 to limit the unintentional movement of power center 10 while it is resting on surface 40. It should be understood that materials other than elastomers that provide a skid-resistant effect may be used without departing from the spirit or scope of the present invention. In addition to skid-resistant feet members, multipurpose power center 10 may also include one or more weight members positioned within housing 12, such as on bottom side 48. The purpose of the weight members is to increase the weight of housing 12 in order to further limit the unintentional movement of power center 10.

Strain relief element 57 is positioned at the connection between network port 16 and network cable 22. In general, the point at which a cable exits a connection or port can be a critical failure point due to flexing or pulling of the cable. Thus, strain relief element 57 is configured to improve the life of network cable 22 by improving the tolerance to flexing or pulling. It is contemplated that similar strain relief elements may also be used at various other cable connections within multipurpose power center 10.

Multipurpose power center 10 also includes power cable fastening element 58, which is depicted in FIG. 2 as a cable or strap. Power cable fastening element 58 is configured to secure power cable 18 within housing 12 such that power cable 18 may not be pulled through bottom side 48, thereby causing a break in power to electrical outlets 14. In particular, power cable fastening element 58 may include any means of securing power cable 18 within housing 12 to prevent power cable 18 from being pulled through bottom side 48.

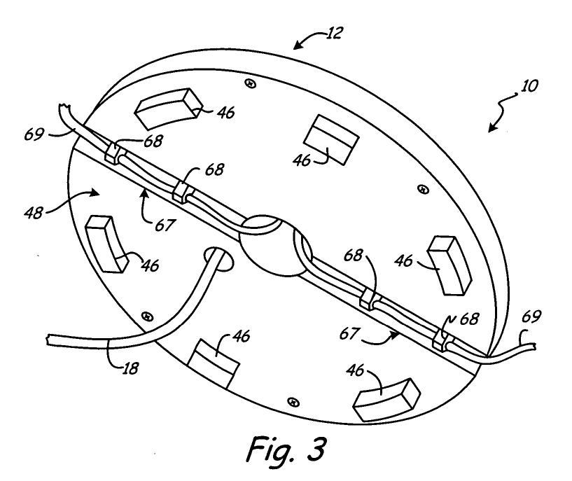

FIG. 3 is a bottom perspective view of multipurpose power center 10, which further includes channels 67 and hooks 68. Although multipurpose power center 10 is shown with two channels and two hooks disposed within each channel, different numbers of channels and hooks are also possible. As shown in FIG. 3, channels 67 are recessed into bottom side 48 of housing 12 and extend from an outer edge of opening 50 to an outer edge of housing 12. This feature gives the user an alternative to merely running cables between bottom side 48 of housing 12 and top side 66 of surface 40, as described above in reference to FIG. 2. As shown in FIG. 3, channels 67 are configured to receive cables 69, which are then secured within channels 67 by hooks 68. By securing cables 69 within channels 67, cables 69 are less likely to become tangled with other cords or cables located near multipurpose power center 10.

Channels 67 and hooks 68 are also beneficial in embodiments that do not include feet members 46. When a multipurpose power center does not include feet members 46, bottom side 48 of housing 12 rests on top side 66 of surface 40, thereby eliminating spatial relationship S. As a result, without recessed channels 67, it would be impossible to run a cable between bottom side 48 of housing 12 and top side 66 of surface 40 whenever necessary or desired.

Although multipurpose power center 10 is shown in FIG. 3 as including both channels 67 and hooks 68, embodiments that include only channels 67 or hooks 68 are contemplated. Furthermore, embodiments that include neither channels 67 nor hooks 68 are also contemplated.

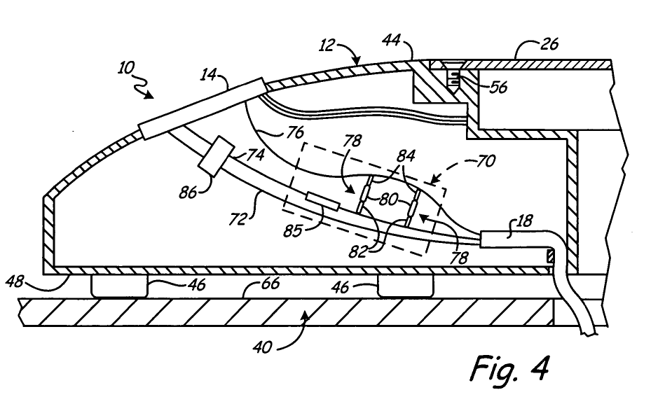

FIG. 4 is a cross-sectional view of multipurpose power center 10 showing one embodiment of surge suppressor 70 connected to power cable 18, which includes neutral line 72, hot power line 74, and ground line 76. Surge suppressor 70 includes one or more varistors 78, such as a metal oxide varistor (MOV), configured to divert extra voltage caused by a voltage surge. As shown in FIG. 4, varistors 78 form a connection between hot power line 74 and ground line 76. In general, each metal oxide type varistor 78 has three parts: metal oxide center 80, joined to hot power line 74 and ground line 76 by first semiconductor 82 and a second semiconductor 84. First and second semiconductors 82 and 84 have a variable resistance that is dependent on voltage. When the voltage running through hot power line 74 is below a certain threshold, the electrons in first and second semiconductors 82 and 84 flow in such a way as to create a very high resistance. However, when the voltage exceeds the threshold level, the electrons flow differently, creating a much lower resistance. In particular, as soon as extra current is diverted into varistors 78 and to ground line 76, the voltage in hot power line 74 returns to a normal level, causing an increase in the resistance of varistors 78. In this way, varistors 78 only divert the surge current, while allowing the standard current to continue powering any devices that are connected to electrical outlets 14. Although surge suppressor 70 has been described in reference to a varistor, other surge suppression means are also within the intended scope of the present invention. Furthermore, although varistors 78 have been described as metal oxide varistors, other types of varistors exist that may take the place of a metal oxide varistor without sacrificing functionality.

As shown in FIG. 4, surge suppressor 70 may also include a built-in fuse 85 as a back-up to varistors 78. In general, fuse 85 acts as a resistor that can easily conduct current through hot power line 74 as long as the current is below a certain threshold. If the current flowing through hot power line 74 increases above the acceptable threshold, the heat caused by the resistance will burn fuse 85, thereby cutting off power to electrical outlets 14. Thus, if varistors 78 do not prevent a power surge, the additional current will burn fuse 85, thereby preventing damage to any devices connected to electrical outlets 14. In other embodiments, fuse 85 may be replaced by another protective device such as a circuit breaker.

In order to protect users from electrical shock, multipurpose power center 10 may also include a ground fault interrupter (GFI) 86 coupled to one or more of electrical outlets 14. As shown in FIG. 4, ground fault interrupter 86 is connected to neutral line 72 and hot power line 74. In one embodiment of a ground fault interrupter, neutral line 72 and hot power line 74 are passed through a sensing coil such that the currents traveling through the lines are moving in opposite directions, resulting in a net zero current. Typically, a GFI is configured to “trip” when there is more than 5 milliamperes of leakage current from the normal pathway (i.e., when neutral line 72 has 5 milliamperes less current than hot power line 74). As stated above, since multipurpose power center 10 is configured to rest on a substantially flat surface, such as a conference room table, it is foreseeable that liquids such as water or coffee may be spilled in the vicinity of multipurpose power center 10. Thus, ground fault interrupter 86 may protect against shocks resulting from such accidents.

Although multipurpose power center 10 is shown in FIG. 4 as including surge suppressor 70 and ground fault interrupter 86, alternative embodiments of multipurpose power center 10 that do not include these components are also within the intended scope of the present invention. In particular, since it is common for electrical outlets in buildings to include surge suppressor and ground fault interrupter systems in the outlets or circuits themselves, surge suppressor 70 and ground fault interrupter 86 may be omitted from multipurpose power center 10 without losing the safety and protection that they provide.

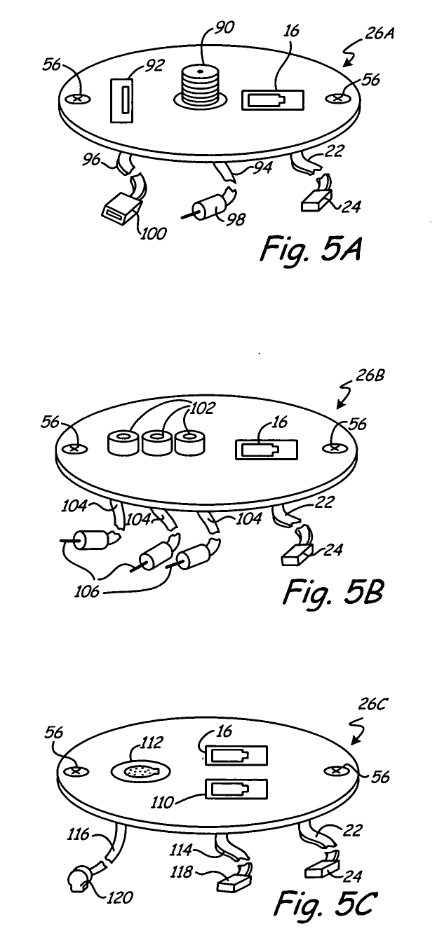

FIG. 5A is a perspective view of a first alternative embodiment of an interchangeable cover member 26A of the present invention. Cover member 26A includes network port 16, coaxial connector 90, Universal Serial Bus (USB) port 92, network cable 22, coaxial cable 94, and USB cable 96. Network cable 22 terminates in network plug 24, coaxial cable 94 terminates in coaxial plug 98, and USB cable 96 terminates in USB plug 100. In particular, network port 16, coaxial connector 90, and USB port 92 are configured to provide connection to, for example, computer networks, video sources or displays, and computer hardware. Furthermore, similar to cover member 26 of FIG. 2, cover member 26A is attachable to housing 12 with the pair of fasteners 56 to encase opening 50 on top side 44 of housing 12.

FIG. 5B is a perspective view of a second alternative embodiment of an interchangeable cover member 26B of the present invention. Cover member 26B includes network port 16, composite ports 102, network cable 22, and composite cables 104. Network cable 22 terminates in network plug 24, while composite cables 104 terminate in composite plugs 106. In particular, network port 16 and composite ports 102 are configured to provide connection to, for example, computer networks, video sources or displays, and audio sources or speakers.

FIG. 5C is a perspective view of a third alternative embodiment of an interchangeable cover member 26C of the present invention. Cover member 26C includes network port 16, telephone port 110, separate video (S-video) port 112, network cable 22, telephone cable 114, and S-video cable 116. Network cable 22 terminates in network plug 24, telephone cable 114 terminates into telephone plug 118, and S-video cable 116 terminates in S-video plug 120. In particular, network port 16, telephone port 110, and S-video port 112 are configured to provide connection to, for example, computer networks, land line telephone systems, and video sources or displays.

It should be noted that the embodiments of interchangeable cover member 26 shown in FIGS. 5A, 5B, and 5C are only three of the possible alternative embodiments, and are presented for purposes of example and not for limitation. Thus, an interchangeable cover member with different types and different numbers of connection ports is within the intended scope of the present invention. For example, other types of cable connection ports including, but not limited to, RGB, component video, DVI, HDMI, optical, and printer may be added to a cover member for use in multipurpose power center 10.

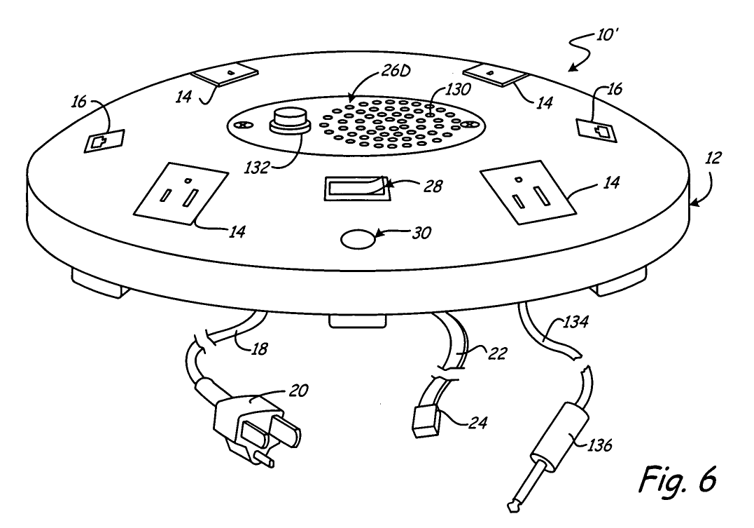

FIG. 6 is a perspective view of multipurpose power center 10′, which includes housing 12, plurality of electrical outlets 14, plurality of network ports 16, power cable 18, power plug 20, network cable 22, network plug 24, and cover 26D. Multipurpose power center 10′ is similar to multipurpose power center 10 shown in FIG. 1. However, multipurpose power center 10′ includes network ports 16 positioned on an outer surface of housing 12 rather than on a cover member. Similar to electrical outlets 14, network ports 16 may be molded into housing 12 or formed as separate components that are later inserted into a plurality of openings within housing 12. Although multipurpose power center 10′ is shown as having a pair of network ports 16, a multipurpose power center having any number of network ports is contemplated.

As shown in FIG. 6, cover 26D is another alternative embodiment of an interchangeable cover member of the present invention. Cover member 26D includes microphone 130, microphone button 132, and microphone cable 134. Microphone cable 134 terminates in microphone plug 136. In particular, microphone 130 is configured to provide connection to, for example, a separate teleconference phone unit. When connected to a teleconference phone unit, microphone 130 serves as a satellite microphone to allow those not seated near the main unit to participate in a teleconference conversation. In other embodiments, microphone 130 may be replaced with a dual purpose microphone/speaker element to allow individuals not seated near the main unit to better hear the conversation as well.

Microphone button 132 is positioned on cover member 26D near microphone 130, and includes both an “on” position and an “off” position. When toggled to the “off” position, microphone 130 is temporarily disconnected, thus allowing for private conversations between those individuals seated near multipurpose power center 10′.

Although the above embodiments depict power center 10 with a low-profile, rounded or dome-shaped housing, housing 12 may take on other shapes including, but not limited to, a square, a rectangle, a pyramid, or a hemisphere, without departing from the intended scope of the present invention. Furthermore, although housing 12 is preferably injection molded with an electrical grade plastic, a housing that is manufactured in a different manner with an alternative suitable material is also contemplated. Also, for ease of assembly, housing 12 is preferably manufactured as two pieces that are secured together after electrical outlets 14 have been wired to electrical cable 18. For example, bottom side 48 may be manufactured as a separate piece and removably secured to housing 12 with a plurality of fasteners.

The terminology used herein is for the purpose of description, and not limitation. Specific structural and functional details disclosed herein are not to be interpreted as limiting, but merely as bases for teaching one skilled in the art to variously employ the present invention. Although the present invention has been described with reference to preferred embodiments, workers skilled in the art will recognize that changes may be made in form and detail without departing from the spirit and scope of the invention.

1. A multipurpose power center comprising:
a housing having an outer surface, a top side, a bottom side, and an opening extending from the top side to the bottom side;
a cover member configured to encase the opening on the top side of the housing;
a plurality of electrical outlets positioned along the outer surface of the housing;
an electrical cable connectable to a power source and configured to provide electrical power to the electrical outlets; and
a connection port coupled to the cover member, wherein the connection port is configured to receive a twisted pair cable.

2. The multipurpose power center of claim 1, wherein the connection port comprises a phone port configured to receive a phone cable.

3. The multipurpose power center of claim 1, wherein the connection port comprises a network port configured to receive a network cable.

4. The multipurpose power center of claim 1, and further comprising a coaxial cable connector coupled to the cover member.

5. The multipurpose power center of claim 1, and further comprising a ground fault circuit interrupter coupled to the electrical outlets.

6. The multipurpose power center of claim 1, and further comprising a surge suppressor configured to prevent a surge of electricity from reaching the electrical outlets.

7. The multipurpose power center of claim 1, and further comprising a recessed channel disposed along the bottom side of the housing, wherein the channel is configured to receive a cable.

8. The multipurpose power center of claim 7, and further comprising a plurality of hook members configured to secure the cable within the recessed channel.

9. A multipurpose power center comprising:
a housing having a bottom side configured to be positionable over a substantially flat surface;
a removable cover member attachable to the housing;
a plurality of electrical outlets disposed along the housing and configured to provide an electrical power source; and
a network port positioned on the removable cover member and configured to provide a network interface.

10. The multipurpose power center of claim 9, wherein the housing further includes an opening extending from a top side to the bottom side of the housing, and wherein the removable cover member is configured to encase the opening when attached to the housing.

11. The multipurpose power center of claim 9, and further comprising a video connection port positioned on the cover member.

12. The multipurpose power center of claim 11, wherein the video connection port comprises a coaxial cable connector.

13. The multipurpose power center of claim 11, wherein the video connection port comprises an S-video port.

14. The multipurpose power center of claim 11, and further comprising an audio connection port positioned on the cover member.

15. The multipurpose power center of claim 9, and further comprising a plurality of feet members disposed along the bottom side of the housing and configured to create a spatial relationship between the housing and the substantially flat surface.

16. The multipurpose power center of claim 15, wherein at least a portion of the feet members is formed from an elastomer.

17. A portable, multipurpose power center comprising:
a housing having a top side, a bottom side, and an opening extending from the top side to the bottom side;
a plurality of electrical outlets disposed along the housing and configured to provide an electrical power source;
a removable cover member attachable to the top side of the housing such that the cover member encases the opening on the top side of the housing;
a network port positioned on the housing and configured to receive a network cable; and
a microphone positioned on the removable cover member and configured to attach to a telephone unit.

18. The multipurpose power center of claim 17, wherein the cover member is attachable to the housing with a plurality of fasteners.

19. The multipurpose power center of claim 17, and further comprising a speaker positioned on the removable cover member and configured to attach to the telephone unit.

20. The multipurpose power center of claim 17, and further comprising a multimedia connection port positioned on the removable cover member and configured to receive a multimedia cable.
